(19) United States
(12) Patent Application Publication
(10) Pub. No.: US 2025/0027768 A1
(43) Pub. Date: Jan. 23, 2025

(54) U-BOLT, DETECTION DEVICE, AND DETECTION METHOD

(71) Applicant: NIPPON TELEGRAPH AND TELEPHONE CORPORATION, Tokyo (JP)

(72) Inventors: Toshiki NAKANISHI, Tokyo (JP); Daiki KOBAYASHI, Tokyo (JP); Atsushi ARATAKE, Tokyo (JP); Yosuke SAKURADA, Tokyo (JP)

(73) Assignee: NIPPON TELEGRAPH AND TELEPHONE CORPORATION, Tokyo (JP)

(21) Appl. No.: 18/709,472

(22) PCT Filed: Nov. 15, 2021
(86) PCT No.: PCT/JP2021/041972

§ 371 Date: May 10, 2024

(51) Int. Cl. G01B 21/16; F16B 35/04; F16L 3/10

(52) U.S. Cl. CPC G01B 21/16; F16B 35/041; F16L 3/1091

(57) ABSTRACT

A U-bolt (1) according to the present invention includes: a pair of shaft parts (111) arranged in a first direction and extending in a second direction orthogonal to the first direction; and one screw part (12) provided on an apex side and one or more screw parts (12) provided on a tip side in each of the pair of shaft parts (111).

### TECHNICAL FIELD

The present disclosure relates to a U-bolt, a detection device, and a detection method. cl BACKGROUND ART

In the related art, a U-bolt has been used to fix a fastener object such as a pipe to a fastened object such as a frame or a wall surface. The U-bolt is a U-shaped bolt in which two linear shaft parts are connected by a bridge part. By inserting the shaft parts of the U-bolt into two respective through-holes provided in the fastened object, in a state where the fastener object is sandwiched inside the U-bolt, and fastening the fastener object from each end part of the two shaft parts with a nut, the fastener object can be sandwiched and fixed by the U-bolt and the fastened object. FIG. 12 shows a structure in which a fastener object such as a pipe is fixed to a fastened part by a U-bolt. When fixing a fastener object such as a pipe by a U-bolt, the fastener object such as the pipe is fixed to a fastened part by fastening left and right nuts, but when used outdoors for a long period of time, the nuts become loosened due to aging, causing the pipe and other fastener objects to detach or metal parts such as the fastened part to come off. Further, there is a risk that the loosened nuts may eventually come off the U-bolt, causing the nuts to fall and cause accidents where the nuts hit a person, an automobile, and the like.

NPL 1 describes a study on the risk of damage and fall of road accessories such as lighting and sign due to aging, and a measure for preventing accidents. A performance evaluation of a super slit nut (SSN) having a new anti-loosening mechanism is described in NPL 2. However, since it is necessary to perform accurate torque control to fix anti-loosening nuts straight against the fastened part, poor installation may occur outdoors where the installation environment is unstable, reducing the effectiveness of the nuts.

### Citation List

### Non Patent Literature

[NPL 1] Fumi Miyahara, and 3 others, “Fall and Collapse Risk Assessment Method for Non-Structural Members of Roads,” Civil Engineering Journal 58-11, p. 12-15, 2016
[NPL 2] Satoshi Izumi, and 7 others, “Functional Verification of Super Slit Nuts with Anti-Looseness Performance by Finite Element Method,” Transactions of the Japan Society of Mechanical Engineers (Series A), Vol. 71, No. 703 (2005-March)

### SUMMARY OF INVENTION

### Technical Problem

An object of the present disclosure, which has been made in view of such circumstances, is to provide a U-bolt that prevents a nut coupled to the U-bolt from falling even if the nut is loosened, and a detection device and a detection method for detecting a descent caused by loosening of the nut. In the present specification, “fall of the nut” means that the nut is completely removed from the shaft part, and “descent of the nut” means that the nut is separated from the screw part on the apex side and caught on and stopped by threads or the like of the screw part on the tip side.

### Solution to Problem

In order to achieve the foregoing object, a U-bolt according to the present disclosure is a U-bolt for fastening a fastener object by using a nut, the U-bolt including a pair of shaft parts arranged in a first direction and extending in a second direction orthogonal to the first direction, and one screw part provided on the apex side and one or more screw parts provided on the tip side in each of the pair of shaft parts.

In order to achieve the foregoing object, a detection device according to the present disclosure is a detection device for detecting a fall of a nut coupled to a U-bolt for fastening a fastener object, the detection device including: a U-bolt that includes a sensor for measuring a distance to an object and a transmission unit for transmitting a measurement result obtained by the sensor; a master unit that includes a reception unit for receiving the measurement result transmitted from the transmission unit, a control unit for determining whether the nut has descended or not based on the measurement result, and an alert issuing unit for issuing an alert when the control unit determines that the nut has descended.

In order to achieve the foregoing object, a detection method according to the present disclosure is a detection method for detecting a fall of a nut coupled to a U-bolt for fastening a fastener object, the detection method including the steps of: measuring a distance to an object; transmitting a measurement result; Transmitting a measurement result; receiving the measurement result; determining whether the nut has descended or not based on the measurement result; and issuing an alert when it is determined that the nut has descended.

### Advantageous Effects of Invention

According to the present disclosure, nuts can be prevented from falling due to loosening.

### BRIEF DESCRIPTION OF DRAWINGS

FIG. 1 is a diagram showing a configuration example of a U-bolt according to a first embodiment.

FIG. 2A shows a cross section of a screw part and a nut at the time of fastening the nut.

FIG. 2B shows a cross section of the screw part and the nut at the time when the nut descends.

FIG. 3 is a cross-sectional view of a U-bolt in which the apex side of the screw part on the tip side is provided with a screw groove which is not screwed to a thread of the nut.

FIG. 4A is a cross-sectional view of a U-bolt in which a start position and an end position of threads of screw parts adjacent to each other match.

FIG. 4B is a cross-sectional view of a U-bolt in which the start position and the end position of the threads of the screw parts adjacent to each other are not aligned.

FIG. 5 is a cross-sectional view of a U-bolt provided with three screw parts on one side.

FIG. 6 is a cross-sectional view of a U-bolt provided with a screw groove which is not screwed to a thread of the nut, and in which a start position and an end position of threads of screw parts adjacent to each other are not aligned.

FIG. 7 is a diagram showing a configuration example of a U-bolt according to a second embodiment.

FIG. 8 is a diagram showing a structure in which a sensor is embedded in a hole opened in a shaft part of the U-bolt and mounted thereon.

FIG. 9A is a schematic view showing a method of supplying power to the sensor via a wired cable.

FIG. 9B is a schematic view showing a method of supplying power to the sensor from a battery embedded in the shaft part.

FIG. 10 is a block diagram illustrating a configuration example of a detection device according to the third embodiment.

FIG. 11 is a flowchart showing an example of a detection method executed by the detection device according to the third embodiment.

FIG. 12 is a diagram showing a structure obtained when a pipe is fixed by a U-bolt.

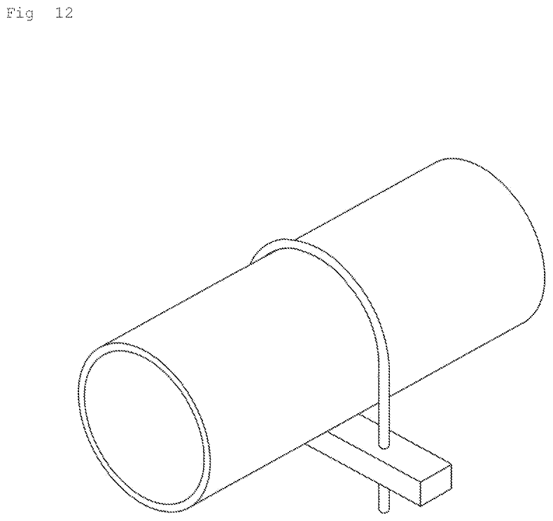

### DESCRIPTION OF EMBODIMENTS

Embodiments of the present disclosure will be described hereinafter with reference to the drawings.

### First Embodiment

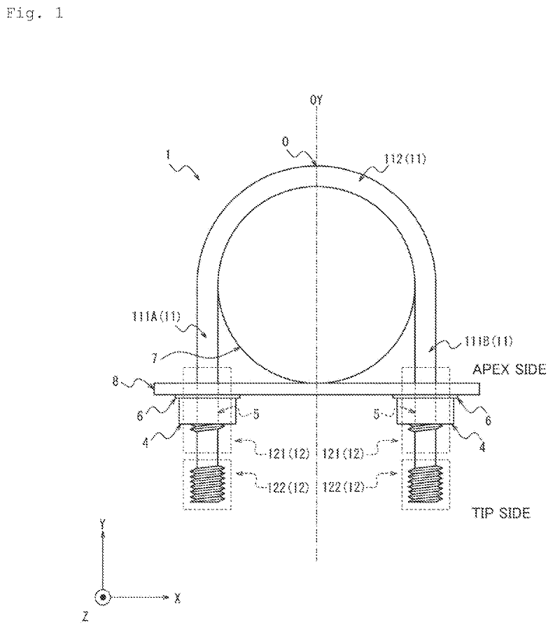

FIG. 1 is a diagram showing a configuration example of a U-bolt 1 according to a first embodiment of the present disclosure.

The U-bolt 1 according to the present embodiment is made of a metal such as steel. As shown in FIG. 1, the U-bolt 1 includes a main body 11 including shaft parts 111A and 111B and a bridge part 112, and a screw part 12. The U-bolt 1 is a U-bolt for fastening a fastener object 7 by using a nut 4.

The shaft part 111A and the shaft part 111B are arranged in a first direction and extend in a direction orthogonal to the first direction. Hereinafter, as shown in FIG. 1, the direction in which the shaft part 111A and the shaft part 111B are arranged side by side is referred to as an X-axis direction (first direction), the direction in which the shaft part 111A and the shaft part 111B extend is referred to as a Y-axis direction (second direction), and a direction orthogonal to the X-axis direction and the Y-axis direction is referred to as a Z-axis direction (third direction). Hereinafter, the shaft part 111A and the shaft part 111B are collectively referred to as a pair of shaft parts 111. Hereinafter, when the shaft part 111A and the shaft part 111B are not distinguished from each other, they are referred to as a shaft part 111.

The bridge part 112 connects respective one end of each of the shaft parts 111. The bridge part 112 is configured line symmetrically with respect to an imaginary straight line OY (hereinafter referred to as an “imaginary line OY”) extending in the Y-axis direction including an U-shaped apex O formed by the U-bolt 1. The bridge part 112 is also provided at one end of each of the shaft parts 111, and has a semi-circular curved shape. Since the bridge part 112 thus configured is provided at one end of the pair of shaft parts as described above, the U-bolt 1 forms a U-shape as a whole.

The screw part 12 has a thread structure. The screw part 12 is provided on each of the pair of shaft parts at one section (a screw part 121 on the apex side) on the apex side and at one or more sections (a screw part 122 on the tip side) on the tip side. In FIG. 1, one screw part 122 is provided on the tip side.

As shown in FIG. 1, the fastener object 7 such as a pipe is disposed inside the U-shaped U-bolt 1 (in the space surrounded by the pair of shaft parts 111 and the bridge part 112). In a state in which the fastener object 7 is disposed inside the U-bolt 1, the shaft part 111A and the shaft part 111B are inserted from one surface side of a fastened object 8 such as support hardware into a pair of through-holes 5 provided in the fastened object 8, respectively. By inserting the shaft part 111A and the shaft part 111B into the pair of through-holes 5, the screw parts 12 of the shaft part 111A and the shaft part 111B protrude to the other surface side of the fastened object 8. The screw parts 12 protruding from the other surface side of the fastened object 8 are fastened by nuts 4. The nuts 4 have threads screwed to threads of the screw parts 12, respectively. Thus, the fastener object 7 is sandwiched and fixed between the U-bolt 1 and the fastened object 8.

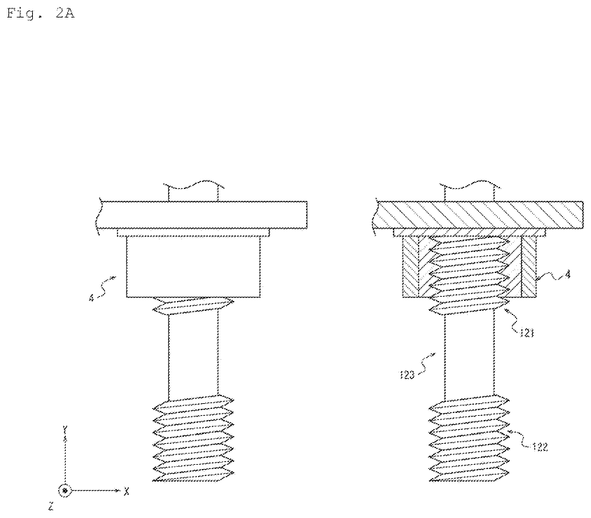

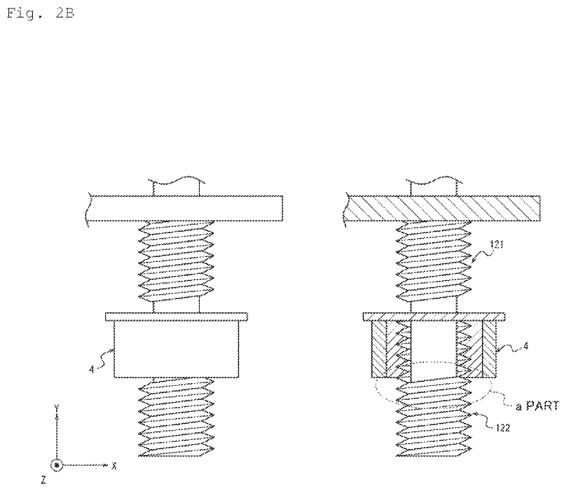

FIGS. 2A and 2B show a structure for preventing the nuts 4 from falling by providing two screw parts 12 of the U-bolt 1 on one side. In the present specification, the term “fall of a nut 4” means that the nut 4 is completely removed from the shaft part 111. FIG. 2A shows cross sections of the screw part 12 and the nut 4 when the nut 4 is fastened, and FIG. 2B shows cross sections of the screw part 12 and the nut 4 when the nut 4 is lowered. In the present specification, the term “descent of the nut 4” means that the nut 4 is separated from the screw part 121 on the apex side and caught on and stopped by the thread or the like of the screw part 122 on the tip side. By providing two screw parts 12 of the U-bolt 1 on one side, when the nut 4 is loosened, the nut 4 stops at a boundary part 123 of the screw part, preventing the nut 4 from falling. In the present specification, the “boundary part 123 of the screw part” refers to a part between the screw part 121 on the apex side and the screw part 122 on the tip side, or between a plurality of shaft parts 122 on the tip side. As shown in part (a) of FIG. 2B, when the male screw of the screw part 122 on the tip side comes into contact with the female screw of the nut 4, the descent of the nut 4 stops. In order to secure the fastening force of the nut 4, it is desirable that the number of turns of the thread is three times or more in one screw part.

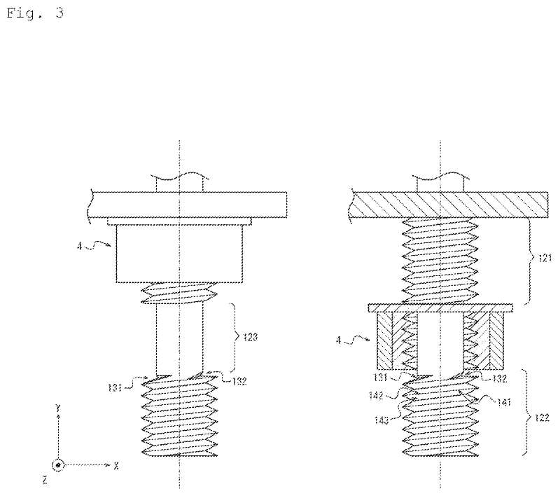

FIG. 3 is a cross-sectional view of a U-bolt in which a screw groove which is not screwed to the thread of the nut is provided on the screw part on the tip side, the screw groove being provided on the apex side of the screw part on the tip side. The screw groove 132 which is not screwed is provided with a cut only on a thread upper surface 142, and is cut so that a thread top 141 remains. By providing the screw groove 132 which is not screwed, the nut 4 that has descended from the screw part 121 on the apex side is caught on the thread of the screw part 122 on the tip side so that the nut 4 is not rotated further, thereby stopping the nut 4 from descending.

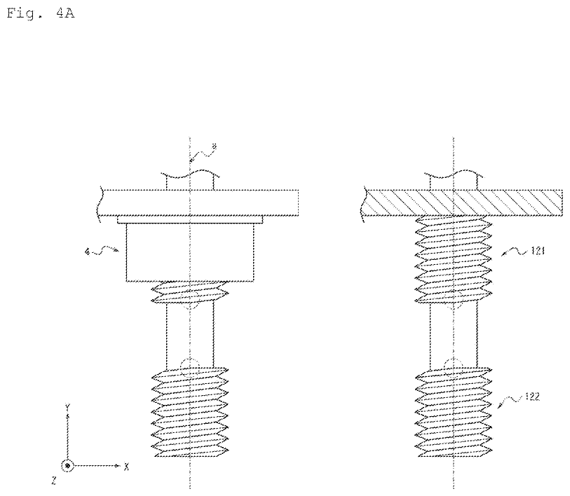

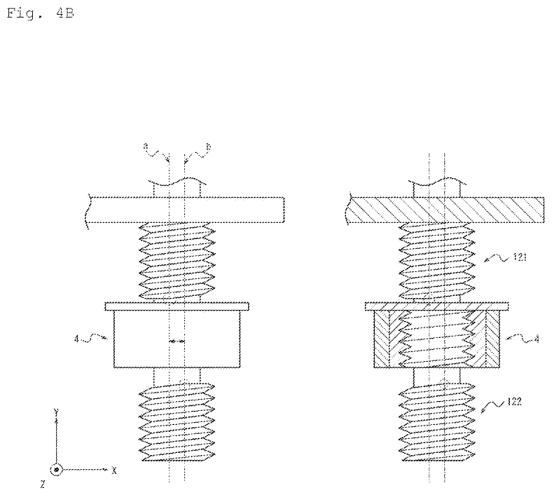

FIG. 4A is a cross-sectional view of a U-bolt in which the start position and the end position of the threads of the screw parts adjacent to each other match. FIG. 4B is a cross-sectional view of the U-bolt in which the start position and the end position of the threads of the screw parts adjacent to each other are not aligned. As shown in FIG. 4B, the start position and the end position of the threads are shifted by an interval between a vertical line a and a vertical line b (that is, the start position and the end position of the threads of the screw parts 12 adjacent to each other are not continuous when viewed from the Y-axis direction). On the other hand, as shown in FIG. 4A, when the start position and the end position of the threads of the screw parts 12 adjacent to each other match along the vertical line a (that is, when the start position and the end position of the threads of the screw parts 12 adjacent to each other are continuous when viewed from the Y-axis direction), there is a possibility that the nut 4 that has descended from the apex side enters the screw part 122 on the tip side, rotates, and eventually fall. Therefore, as shown in FIG. 4B, by shifting the start position and the end position of the threads of the screw parts 12 adjacent to each other, the nut 4 is prevented from entering the screw part 122 on the tip side and falling.

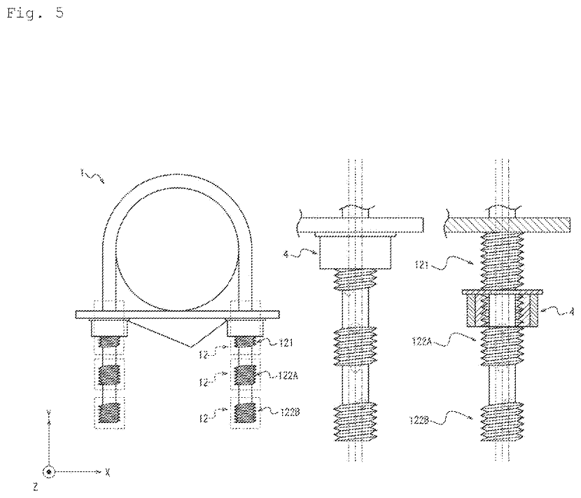

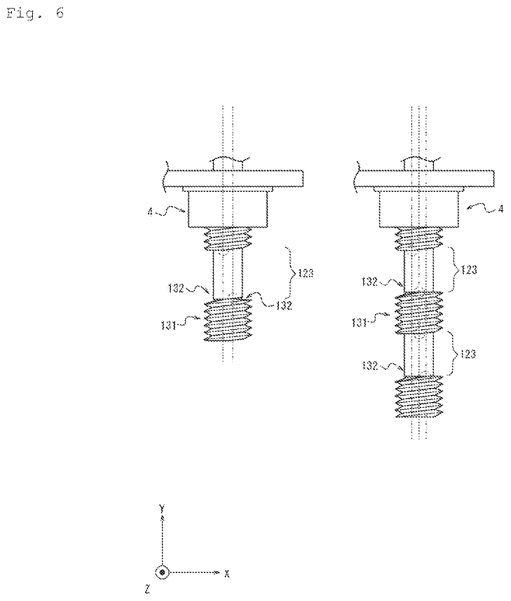

FIG. 5 is a cross-sectional view of a U-bolt in which three or more screw parts are provided on each of the pair of shaft parts. By providing three or more screw parts 12 of the U-bolt 1 on one side, the nut 4 can be prevented from falling, and a time it takes for the nut 4 to fall when loosened can be extended. In order to secure the fastening force of the nut 4, it is desirable that the number of turns of the thread is three times or more in one screw part. FIG. 6 is a cross-sectional view of a U-bolt in which a screw groove which is not screwed to the thread of the nut is provided, and the start position and the end position of the threads of the screw parts adjacent to each other are not aligned. As shown in FIG. 6, by shifting the start position of the thread and the end position of the thread of the thread parts adjacent to each other, it is possible to reduce the possibility that the nut 4 that has descended again rotates and falls. Further, as shown in FIG. 6, by providing a screw groove 132 which is not screwed to the thread of the nut 4, the nut 4 can be prevented from falling.

Thus, the U-bolt 1 according to the present disclosure includes one screw part on the apex side and one or more screw parts on the tip side, respectively, on the pair of shaft parts 111. Therefore, the U-bolt 1 can prevent the nut 4 from falling due to loosening thereof.

### Second Embodiment

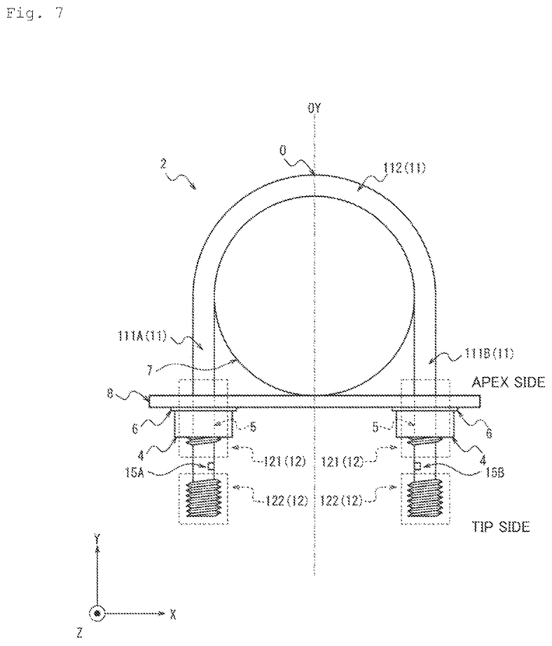

FIG. 7 is a diagram showing a configuration example of a U-bolt 2 according to a second embodiment of the present disclosure.

The U-bolt 2 according to the present embodiment is made of a metal such as steel. As shown in FIG. 7, the U-bolt 2 includes the main body 11 including the shaft parts 111A and 111B and the bridge part 112, the screw part 12, and sensors 15A and 15B. The U-bolt 2 according to the present embodiment is different from the U-bolt 1 according to the first embodiment in that the U-bolt 2 further includes the sensor 15A and the sensor 15B. The same configurations as those of the first embodiment are denoted by the same reference numerals as those of the first embodiment and description thereof will be appropriately omitted.

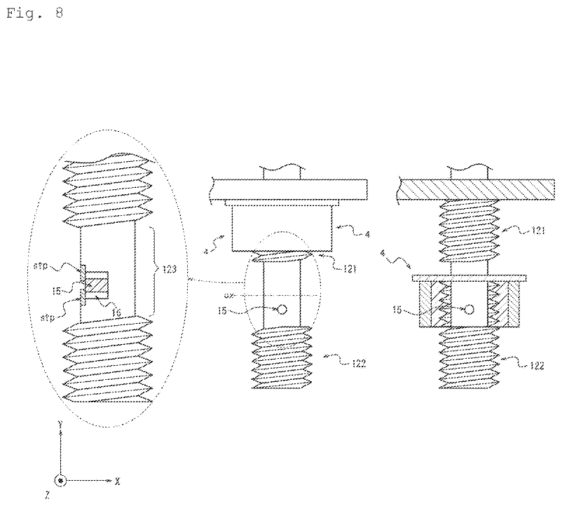

FIG. 8 is a view showing a structure in which a sensor is embedded in a hole opened in a U-bolt shaft part. As shown in FIG. 8, the U-bolt 2 further includes a sensor 15 that is fixed to the inside of a hole 16 formed in a boundary part 123 between screw parts adjacent to each other, and measures a distance to an object positioned in the X-axis direction (first direction). In order to prevent the sensor 15 from separating from the hole 16 and falling down, a stopper stp may be provided on the outer periphery of the hole 16. The stopper stp is provided by welding the same metal material as the metal constituting the shaft part to the outer periphery of a hole 16 opened in the shaft part. Further, even if the stopper stp is not provided, the sensor 15 can be prevented from falling, by filling the inside of the hole 16 with a resin such as an adhesive and fixing the sensor 15. Hereinafter, when the sensor 15A and the sensor 15B are not distinguished from each other, they are referred to as a sensor 15. Hereinafter, the sensor 15A and the sensor 15B are collectively referred to as a pair of sensors 15.

By mounting the sensor 15, a descent of the nut 4 from the apex side can be detected. When the nut 4 that has descended from the apex side stops at the screw part 122 on the tip side, the sensor 15 reacts to detect that the nut 4 has descended. The hole 16 is preferably formed at a position closer to the tip side than the center of the boundary part 123 of the screw part (the position indicated by a broken line OX). This is because the sensor 15 can easily detect the nut 4 when the nut 4 descends, gets caught on the thread of the screw part 122 on the tip side, and stops.

When foreign matter such as a dead leaf adheres to the hole 16 accommodating the sensor 15, the sensor 15 may erroneously detect that the nut 4 has descended. Then, as shown in FIG. 7, the sensors 15A and 15B are embedded in the boundary part 123 of the screw parts of both shafts in the opposing direction. Thus, the sensors 15A and 15B can determine whether the nut 4 has descended or whether foreign matter is stuck to the other sensor 15.

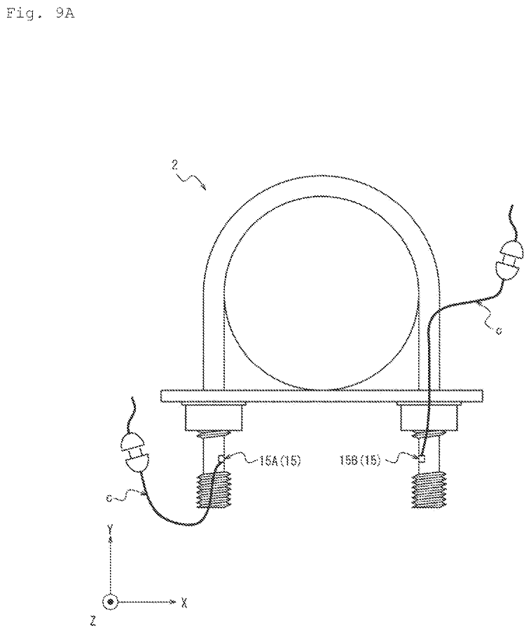

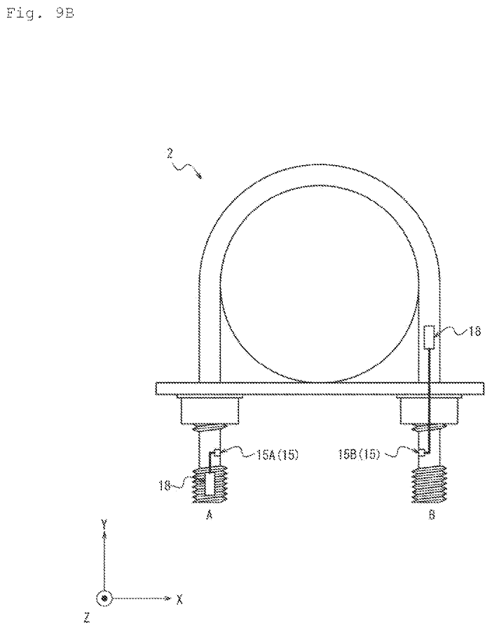

The sensor 15 is a sensor that measures the distance to an object by irradiating the object with ultrasonic waves, infrared rays, laser or the like. FIG. 9A is a schematic view showing a method of supplying power to a sensor via a wired cable. FIG. 9B is a schematic view showing a method of supplying power from a battery embedded in a shaft part to a sensor. Since the sensor 15 requires power supply, power is supplied by utilizing a method of supplying power from the outside via a wired cable c shown in FIG. 9A, a method of supplying power from a battery 18 embedded in a shaft part shown in FIG. 9B, and the like. In view of the structure of the U-bolt 2, power supply can be carried out from both directions of the tip side and the apex side, and since the minimum outer diameter of standardized commercial batteries is 7.9 mm, it is preferred that the diameter of the U-bolt 2 be 10 mm or more.

Thus, the U-bolt 2 according to the present disclosure further includes the sensor 15 for detecting a descent of the nut 4. Therefore, the U-bolt 2 can prevent the nut 4 from falling due to loosening, and can detect a descent of the nut 4.

### Third Embodiment

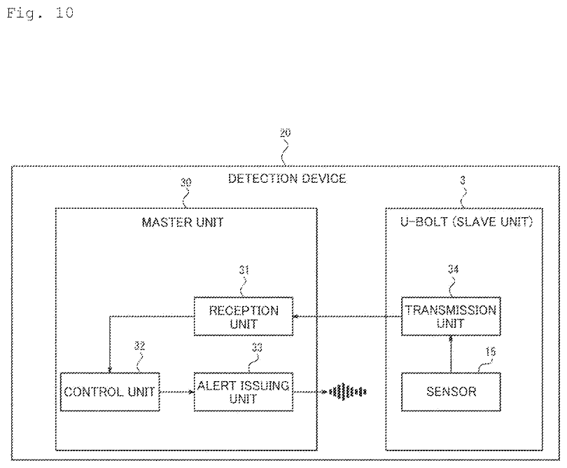

FIG. 10 is a block diagram illustrating a configuration example of a detection device according to a third embodiment. As shown in FIG. 10, a detection device 20 according to the third embodiment includes a master unit 30 including a reception unit 31, a control unit 32, and an alert issuing unit 33, and a U-bolt 3 including the sensor 15 and a transmission unit 34. The detection device 20 detects a descent of a nut coupled to a U-bolt fastened to a fastened object. The sensor 15 related to the U-bolt 3 may be the same as the sensor 15 related to the second embodiment. The detection device 20 may be constituted of one master unit 30 and a plurality of U-bolts 3. The same configurations as those of the second embodiment are denoted by the same reference numerals as those of the second embodiment and description thereof will be appropriately omitted.

The master unit 30 determines whether the nut 4 has descended or not on the basis of a measurement result (distance from the sensor 15 to the object) transmitted from the U-bolt 3, and issues an alert when determining that the nut 4 has descended.

The reception unit 31 receives the measurement results transmitted from the transmission unit of the U-bolt 3. The reception unit 31 outputs the transmission result to the control unit 32. The transmission of the measurement result from the transmission unit 34 of the U-bolt 3 to the reception unit 31 of the master unit 30 may be performed by wired communication, by wireless communication such as Wi-Fi, or by combination thereof.

The control unit 32 determines whether the nut 4 has descended or not on the basis of the measurement result input from the reception unit 21. When determining that the nut 4 has descended, the control unit 32 outputs the resultant determination result to the alert issuing unit 33. The control unit 32 can determine whether or not only a nut 4A on one side has descended, whether or not only the other nut 4B has descended, whether or not the nuts 4A and 4B have descended, and whether or not measurement is impossible due to adhesion of foreign matter to both sensors 15A and 15B, and output the resultant determination result to the alert issuing unit 33. When it is determined that the nut 4A or 4B has descended or there is not foreign matter adhered to both sensors 15A and 15B, the control unit 32 continues the determination of the measurement result.

When the control unit 32 determines that the nut has descended, the alert issuing unit 33 inputs the determination result indicating that the nut 4 has descended from the control unit 32, and issues an alert. The alert issuing unit 33 issues an alert A when only one nut 4A has descended, and issues an alert B when only the other nut 4B has descended. When the nuts 4A and 4B have descended, and when foreign matter adheres to both sensors 15A and 15B and measurement is impossible, an alert C is issued.

The U-bolt 3 transmits the measurement result obtained by the sensor 15 measuring the distance to the object, to the master unit 30.

The transmission unit 34 transmits the measurement result obtained by the sensor 15, to the reception unit 31 of the master unit 30.

### Detection Method

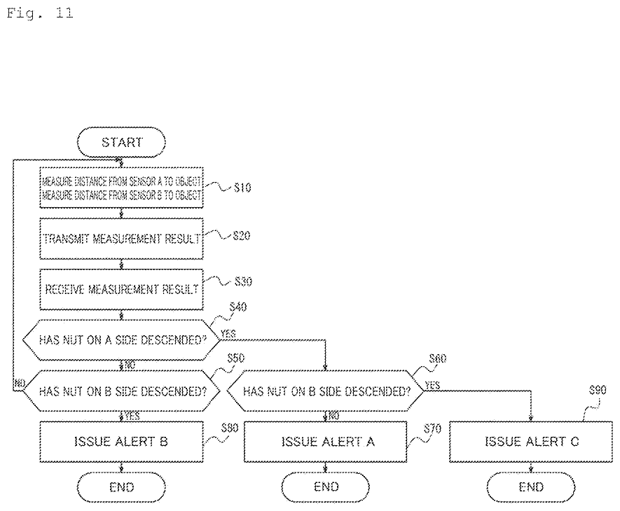

FIG. 11 is a flowchart showing an example of a detection method executed by the detection device 20 according to the third embodiment.

In step S10, the sensor 15A of the U-bolt 3 measures the distance from the sensor 15A to an object, and the sensor 15B measures the distance from the sensor 15B to an object.

In step S20, the transmission unit 34 of the U-bolt 3 transmits the measurement results to the reception unit 31 of the master unit 30.

In step S30, the reception unit 31 of the master unit 30 receives the measurement results and outputs the measurement results to the control unit 32.

In step S40, the control unit 32 of the master unit 30 determines whether or not the nut 4A (nut on the A side) has descended. If the nut 4A has not descended, the processing proceeds to S50. If the nut 4A has descended, the processing proceeds to S60.

In step S50, the control unit 32 of the master unit 30 determines whether or not the nut 4B (nut on the B side) has descended. If the nut 4B has descended, the processing proceeds to S80. If the nut 4B has not descended, the processing returns to S10 and the measurement is continued.

In step S60, the control unit 32 of the master unit 30 determines whether or not the nut 4B has descended. If the nut 4B has not descended, the processing proceeds to S70. If the nut 4B has descended, the processing proceeds to S90.

In step S70, the alert issuing unit 33 of the master unit 30 issues the alert A indicating the descent of the nut 4A.

In step S80, the alert issuing unit 33 of the master unit 30 issues the alert B indicating the descent of the nut 4B.

In step S90, the alert issuing unit 33 of the master unit 30 issues the alert C indicating a descent of the nuts 4A and 4B or adhesion of foreign matter to both sensors 15A and 15B.

As described above, the detection device 20 according to the present disclosure includes the U-bolt 3 including the sensor 15 for detecting a descent of the nut 4, and the master unit 30 for determining whether or not the nut 4 has descended and issuing an alert when the nut 4 descends. Therefore, the detection device 20 detects a descent of the nut 4 due to loosening thereof and issues an alert, so that the worker can know the descent of the nut 4 and the like.

Although the above embodiments have been described as representative examples, it is apparent to those skilled in the art that many modifications and substitutions can be made within the gist and scope of the present disclosure. Therefore, the present invention should not be interpreted as being limited by the foregoing embodiments and can be modified or altered in various ways without departing from the scope of the claims.

### REFERENCE SIGNS LIST

1, 2, 3 U-bolt
4, 4A, 4B Nut
5 Through-hole
6 Washer
7 Fastener object
8 Fastened object
11 Main body
111, 111A, 111B Shaft part
112 Bridge part
12 Screw part
121 Screw part on apex side
122 Screw part on tip side
123 Boundary part of screw part
13 Screw groove
131 Screw groove screwed to thread of nut
132 Screw groove not screwed to thread of nut
14 Thread
141 Thread top
142 Thread upper surface
143 Thread lower surface
15, 15A, 158 Sensor
16 Opened hole
17 Battery
20 Detection device
30 Master unit
31 Reception unit
32 Control unit
33 Alert issuing unit
34 Transmission unit

1. A U-bolt for fastening a fastener object by using a nut, comprising:
a pair of shaft parts arranged in a first direction and extending in a second direction orthogonal to the first direction; and
one screw part provided on an apex side and one or more screw parts provided on a tip side in each of the pair of shaft parts.

2. The U-bolt according to claim 1, wherein the screw part on the tip side is provided with a screw groove that is not screwed to a thread of the nut,
the screw groove that is not screwed being provided on a top side of the screw part on the tip side.

3. The U-bolt according to claim 1, wherein a start position and an end position of threads of the screw parts adjacent to each other are not aligned.

4. The U-bolt according to claim 1, further comprising a sensor that is fixed to the inside of a hole opened in a boundary part between the screw parts adjacent to each other, and measures a distance to an object located in the first direction.

5. A detection device for detecting a descent of a nut coupled to a U-bolt for fastening a fastener object, comprising:
a U-bolt including a sensor for measuring a distance to an object and a transmission unit for transmitting a measurement result obtained by the sensor;
a master unit that includes a reception unit for receiving the measurement result transmitted from the transmission unit,
a control unit for determining whether the nut has descended or not based on the measurement result, and
an alert issuing unit for issuing an alert when the control unit determines that the nut has descended.

6. A detection method for detecting a descent of a nut coupled to a U-bolt for fastening a fastener object, comprising the steps in which a detection device:
measures a distance to an object;
transmits a measurement result;
receives the measurement result;
determines whether the nut has descended on the basis of the measurement result; and
issues an alert when it is determined that the nut has descended.

7. The U-bolt according to claim 1, wherein a bridge connects one end of each pair of shafts and the bridge is symmetrical with respect to a Y-axis direction.

8. The U-bolt according to claim 7, wherein the bridge is provided at one end of each pair of the shafts and has a shape bent in a semicircular shape.

9. The U-bolt according to claim 7, wherein the each of the pair of shafts comprising one thread and a plurality of threads is provided on a tip side.

10. The U-bolt according to claim 1, wherein a thread boundary is provided between an apical thread and distal thread.

11. The U-bolt according to claim 10, wherein the tread boundary is provided between a plurality of distal shafts.

12. The U-bolt according to claim 9, wherein the thread on the tip side is provided with a thread groove that does not engage with a thread of a nut, and the thread groove that does not screw together is provided on a top side of the thread on the tip side.

13. The U-bolt according to claim 9, wherein a start position of the thread adjacent to each other when viewed in the Y-axis direction are offset from each other and an end position of the thread is not consecutive.

14. The U-bolt according to claim 9, wherein the thread is provided at three or more locations on each of the pair of shafts.

15. The detection device of claim 5, wherein a stopper is provided on outer circumference of a hole provided on the U-bolt shaft and the stopper is attached by welding to the shaft.

16. The detection device of claim 5, wherein a pair of sensors facing each other is embedded in a boundary of a thread of shafts.

17. The detection device of claim 5, wherein the sensor measures distance to an object by irradiating the object with ultrasonic waves, infrared rays, or lasers.

18. The U-bolt according to claim 1, wherein a non-threaded thread groove is provided only on a top surface of a thread.

19. The U-bolt according to claim 2, wherein one thread is provided on the top side and one or more thread is provided on the tip side.

20. The detection device of claim 5, wherein a battery is provided to the sensor wherein the battery is wired to an outside source or embedded within the shaft.
